(19) United States
(12) Patent Application Publication
(10) Pub. No.: US 2016/0127239 A1
(43) Pub. Date: May 5, 2016

(54) NETWORK CONFIGURATION SETTINGS SOURCED BY USER EQUIPMENT

(71) Applicant: Alcatel-Lucent USA Inc., Murray Hill, NJ (US)

(72) Inventors: Colin L. Kahn, Morris Plains, NJ (US); Harish Viswanathan, Morristown, NJ (US)

(21) Appl. No.: 14/531,490

(22) Filed: Nov. 3, 2014

(51) Int. Cl. H04L 12/801; H04L 12/24

(52) U.S. Cl. CPC H04L 47/12; H04L 41/0813

(57) ABSTRACT

Systems and methods for User Equipment (UE) to request setting of a configuration of a network. One embodiment includes UE for a telecommunication network. The UE includes a transceiver configured to communicate with a base station of a mobile operator network comprising a Radio Access Network (RAN) and a packet core, and a controller. The controller is able to identify one or more applications residing on the UE, to determine a configuration for the mobile operator network that indicates how one or more elements of the mobile operator network will provide services for applications identified as residing on the UE, to generate a signaling message that describes the configuration, and to transmit the signaling message to the base station to implement the configuration at the mobile operator network for setting how packets are transferred by the mobile operator network between the UE and a Packet Data Network (PDN).

### FIELD OF THE INVENTION

The invention relates to the field of mobile telecommunications technology.

### BACKROUND

A 3G/4G network provides mobile data services to User Equipment (UE) such as smartphones, cellular phones, laptops, tablets, smart watches, machine type communication devices such as a medical monitoring devices, and the like. For example, UEs may engage in sessions with a 3G/4G network in order to exchange packets of data with a Packet Data Network (PDN) such as the Internet or a private corporate network. Each session may be assigned a Quality of Service (QoS) based on an entry in a Home Subscriber Server (HSS). More typically, a network connects individual UEs to a default bearer that provides a one-size-fits-all set of service characteristics.

Providing the same type of service to each UE in a network often leads to inefficiencies at the network, because each device may be utilizing different network services in order to achieve different goals. For example, a fixed medical monitoring device may have no need for mobility tracking, while a cellular phone may require mobility tracking in order to function properly. Despite these differences in how a network may be used by various applications and/or devices, the network typically has little knowledge of the device and/or applications that are requesting access. Therefore, it remains a challenge to ensure that 3G/4G networks efficiently provision services to UEs.

### SUMMARY

Embodiments described herein provide a UE that is capable of requesting that a mobile network adapt its configuration to provide services for specific applications on the UE. The network may then program its network elements to implement the requested configuration, setting/altering how packets are transferred by the mobile operator network between the UE and a PDN.

One embodiment includes User Equipment (UE) for a telecommunication network. The UE includes a transceiver, configured to communicate with a base station of a mobile operator network comprising a Radio Access Network (RAN) and a packet core, and a controller. The controller is able to identify one or more applications residing on the UE, to determine a configuration for the mobile operator network that indicates how one or more elements of the mobile operator network will provide services for respective ones of the one or more applications identified as residing on the UE, to generate a signaling message that describes the configuration, and to transmit the signaling message to the base station to implement the configuration at the mobile operator network, for setting how packets are transferred by the mobile operator network between the UE and a Packet Data Network (PDN).

In a further embodiment, the configuration indicates a mobility anchor to be used by the mobile operator network for the UE.

In a further embodiment, the configuration indicates whether to predictively cache content from the PDN at the UE.

In a further embodiment, the configuration indicates whether packets are transferred between the UE and the PDN without reserving a radio channel between the UE and the base station.

In a further embodiment, the configuration indicates whether congestion avoidance scheduling techniques will be used to communicate with the UE.

In a further embodiment, the controller is configured to include a profile within the signaling message, wherein the profile indicates the configuration.

In a further embodiment, the signaling message names a profile stored at the network, and the profile indicates the configuration.

In a further embodiment, the configuration includes at least one network setting selected from the group consisting of: mobility anchors, security settings, device content caching settings, battery saving mode settings, congestion avoidance scheduling settings, quality of service settings, and reliability settings.

Another embodiment is an apparatus that includes a network control element of a mobile operator network that comprises a Radio Access Network (RAN) and a packet core. The network control element includes an interface able to receive a signaling message for User Equipment (UE) via a base station, and a controller. The controller is able to identify the UE that generated the signaling message, to analyze the signaling message to determine a requested configuration for the mobile operator network indicating how one or more elements of the mobile operator network will provide services for an identified application residing on the UE, and to program the one or more elements of the network to implement the requested configuration for the UE at the mobile operator network, thereby setting how packets are transferred by the mobile operator network between the UE and a Packet Data Network (PDN).

Another embodiment is a method that includes receiving a signaling message for User Equipment (UE) via a base station of a mobile operator network that comprises a Radio Access Network (RAN) and a packet core, and identifying the UE that generated the signaling message. The method further includes analyzing the signaling message to determine a requested configuration for the mobile operator network indicating how one or more elements of the mobile network will provide services for an identified application residing on the UE, and programming the one or more elements of the network to implement the mobility anchor for the UE at the mobile operator network, thereby setting how packets are transferred by the mobile operator network between the UE and a Packet Data Network (PDN).

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a telecommunication network in an exemplary embodiment.

FIG. 2 is a block diagram of UE in an exemplary embodiment.

FIG. 3 is a block diagram of a network control element in an exemplary embodiment.

FIG. 4 is a flowchart illustrating a method for operating a UE in an exemplary embodiment.

FIG. 5 is a flowchart illustrating a method for operating a network control element in an exemplary embodiment.

FIG. 6 is a diagram illustrating multiple potential mobility anchoring elements in an exemplary embodiment.

FIG. 7 is a message diagram illustrating communications across a telecommunication network in an exemplary embodiment.

FIG. 8 illustrates exemplary configurations requested by UEs in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

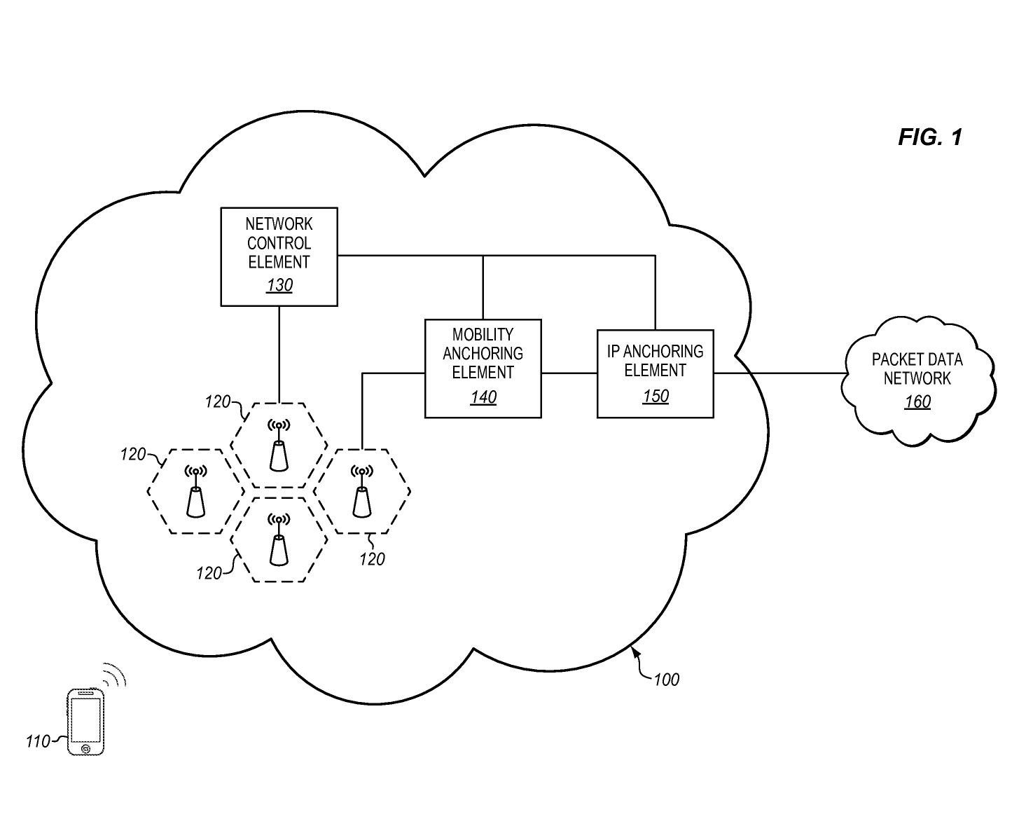

FIG. 1 is a block diagram of a telecommunication (telecom) network 100 in an exemplary embodiment. Network 100 comprises any system operable to exchange data with UE 110 in order to provide voice and/or data services between UE 110 and PDN 160. In this embodiment, network 100 utilizes multiple network elements to exchange data between UE 110 and PDN 160. Specifically, UE 110 anchors itself to one of base stations 120 via Radio Access Network (RAN) communications in order to establish an air interface. The base station 120 that UE 110 is anchored to then communicates with other network elements to establish a bearer that carries communications from the anchor base station 120 to PDN 160. As used herein, base stations 120 form part of a RAN, while network control element 130, mobility anchoring element 140, and IP anchoring element 150 form a packet core (e.g., an Evolved Packet Core (EPC)). The RAN and packet core together form “mobile operator network” 100 that acts as a bridge between UE 110 and PDN 160.

In order to properly establish and maintain the bearer, network 100 assigns a mobility anchoring element 140 that tracks the base station 120 to which UE 110 is currently anchored. Meanwhile, Internet Protocol (IP) anchoring element 150 manages IP connections between UE 110 and an Access Point Name (APN) or any other suitable gateway leading to PDN 160. Mobility anchoring element 140 and IP anchoring element 150 may be implemented as a blade server operating a processor and memory to provision a virtual machine, or by utilizing any other suitable combination of components and devices.

The types of data exchanges described above, where air interfaces and bearers are established/reserved for UE in order to exchange data with a PDN, are referred to as “sessions.” In addition to session-based communications, some exchanges of data that occur along network 100 do not use sessions. For example, mobility tracking is used to determine where UE 110 has moved over a period of time by detecting the base station/s that UE 110 attaches to, and/or by detecting the tracking area/s that UE 110 has visited.

As described herein, the mobile operator network of FIG. 1 has been enhanced to dynamically set/alter the way in which it is configured in order to provide specific levels of service to UE 110, based on requests received from UE 110. Specifically, network control element 130 is capable of identifying network configurations requested by UE 110 in order to provide services to applications of UE 110. Network control element 130 is further capable of configuring/programming elements of network 100 in order to set/alter how network 100 exchanges data with UE 110. For example, network control element 130 may configure/program elements to implement different mobility anchors, security settings, device content caching settings, battery saving mode settings, congestion avoidance scheduling settings, quality of service settings, and/or reliability settings.

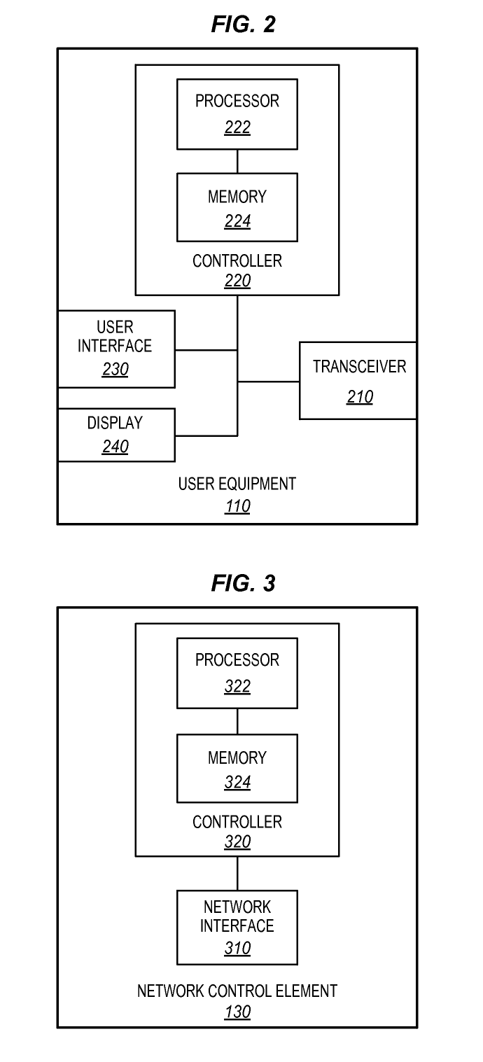

FIGS. 2-3 illustrate further details of UE 110 and network control element 130 in an exemplary embodiment respectively. According to FIG. 2, example UE 110 includes transceiver 210 and controller 220. Transceiver 210 is any component capable of communicating over an air interface with base stations 120 of network 100. Controller 220 manages the operations of UE 110 as it communicates with network 100. In the illustrated embodiment, controller 220 may receive user input via user interface 230, and may update display 240 to display call information or other data as desired. Furthermore, in this embodiment controller 220 is implemented by a hardware processor 222 performing instructions stored in memory 224.

According to FIG. 3, the example embodiment of network control element 130 includes interface 310 and controller 320. Interface 310 comprises any component capable of receiving wired or wireless data for processing by controller 320. Controller 320 manages the operations of network control element 130 as it programs/configures network 100. In the illustrated embodiment, controller 320 is implemented by a hardware processor 322 performing instructions stored in memory 324.

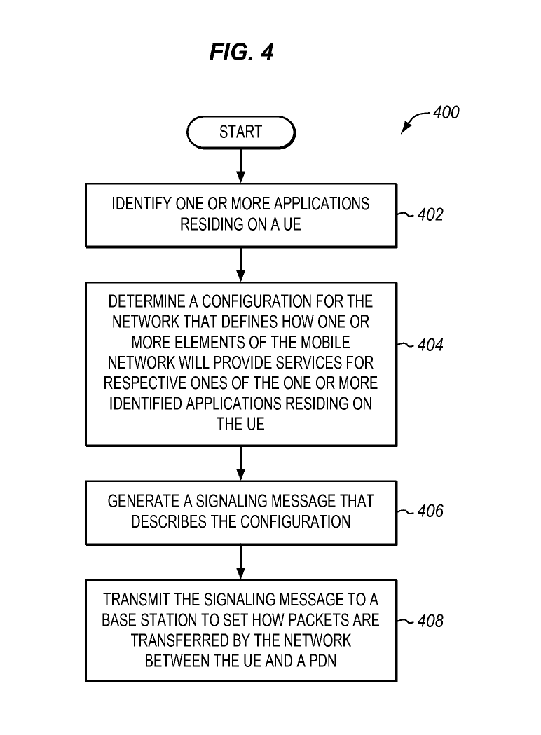

Details of the operation of network 100 will be discussed with regard to FIGS. 4-7. Assume, for this example embodiment, that UE 110 has just powered on within the range of a base station 120 of network 100. FIG. 4 is a flowchart illustrating a method 400 for operating a UE 110 in an exemplary embodiment. The steps of method 400 are described with reference to network 100 of FIG. 1, but those skilled in the art will appreciate that method 400 may be performed in other systems. The steps of the flowcharts described herein are not all inclusive and may include other steps not shown. The steps described herein may also be performed in an alternative order.

According to FIG. 4, in step 402, controller 220 identifies one or more applications on UE 110. For example, controller 220 may identify applications (e.g., application-layer content according to the Open Systems Interconnect (OSI) model) that are expected to be loaded in memory at UE 110. Or, controller may identify applications that are actively loaded in memory at UE 110 and will be used to communicate with PDN 160. Controller may identify applications expected to be loaded and/or applications that are actively loaded. These applications may each be associated with a different preferred group of network settings. In step 404, controller 220 determines a configuration to be used for network 100. The configuration defines/requests how one or more elements of network 100 will provide services for ones of the one or more the identified application(s) on UE 110. For example, the configuration may include settings that request a mobility anchor used to cover a certain geographic range or a certain set of base stations, settings that request a specific network element (or type of network element) to use as a mobility anchor, settings that request encryption in communications carried by network 100 between UE 110 and PDN 160, etc.

Further settings may also be determined by controller 220. For example, settings may be determined by controller 220 based on whether UE 110 is roaming, what applications are running on UE 110, the model and/or capabilities of UE 110, a time of day (e.g., peak vs. non-peak), and other factors. In one embodiment, the configuration is stored at UE 110 in the form of one or more service profiles, where each service profile is named based on a desired characteristic (e.g., “low cost service”), and each service profile includes selected settings for programming/configuring network elements to provide that characteristic to UE 110.

In step 406, controller 220 of UE 110 generates a signaling message (e.g., an attach request) for the base station 120. The message describes the desired configuration, and may include a reserved portion that indicates each desired setting for the configuration. For example, a reserved or custom portion of an attach request may be used to explicitly list any desired settings, or to identify (e.g., by name, by ID, etc.) a profile for a configuration stored at network 100 (each stored configuration at the network detailing corresponding settings). In step 408, controller 220 operates transceiver 210 to transmit the signaling message to the base station 120. The signaling message, because it defines a configuration for network elements to be used in providing services to UE 110 (e.g., by defining settings for mobility anchors, reliability, security, battery saving, communication times, device content caching, quality of service, etc.), will set/alter how packets are transferred between UE 110 and PDN 160. Once the signaling message has been transmitted, UE 110 awaits a response from the base station 120. The response from the base station may indicate whether (and/or which) requested settings have been enabled at the network.

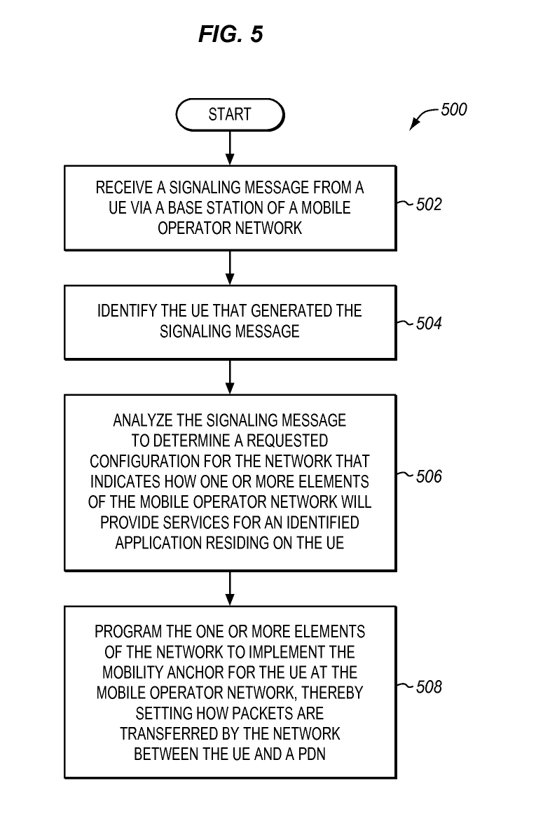

FIG. 5 is a flowchart illustrating a method 500 for operating network control element 130 in an exemplary embodiment. Method 500 is performed while UE 110 is waiting for a response to the signaling message, and is triggered in response to the base station 120 forwarding all or part of the signaling message to network control element 130.

In step 502, network control element 130 receives the signaling message from UE 110. The signaling message provides information in accordance with cellular protocols for the base station 120 to track and/or communicate with UE 110.

In step 504, controller 320 identifies the UE that generated the signaling message, which in this case is UE 110. As a part of the identification process, controller 320 may review the signaling message for information identifying UE 110, such as a Subscriber Identity Module (SIM) ID, a telephone number, or a Uniform Resource Identifier (URI).

Controller 320 analyzes the signaling message to determine the configuration requested for the network with respect to UE 110 (step 506). The requested configuration indicates how one or more elements of the network will provide services for one or more applications residing on UE 110. In one embodiment, the signaling message explicitly lists each desired setting for network 100 (e.g., in a profile), while in another embodiment, the signaling message includes a reference to a group of settings maintained on the network (e.g., as a profile stored at network control element 130 or a network database). In yet another embodiment, the signaling message includes a list of applications used by UE 110, and controller 320 determines how network 100 should be configured to implement desired features for each listed application. In such an embodiment, controller 320 is application aware, and is therefore capable of adjusting network settings for UE 110 to better meet the needs of active applications on UE 110.

Controller 320 then decides whether to implement each of the requested configuration settings of the network with respect to UE 110. As a part of this analysis, controller 320 may consider what resources are available within network 100 to determine whether the settings may be implemented without negatively impacting network 100. Controller 320 may further consider an operator policy that is defined for the network and associated with a subscriber for UE 110, subscriber analytics for the network that indicate the behavior of a subscriber for UE 110, and network analytics for the network that indicate a level of traffic at the network before deciding whether or not to implement the requested changes relating to the settings for the network. In one embodiment, settings that require a greater amount of network resources (e.g., memory, processing power, bandwidth, etc.) are more likely to be denied if network traffic is already heavy, or if a subscriber is not a preferred subscriber. Denial in this manner ensures that telecom network 100 is able to provide services to a large number of customers/devices, even when under heavy load.

If the request is not approved, then network control element 130 sends a rejection message to UE 110. Alternatively, if the request is approved by controller 320, the controller operates interface 310 to program/configure the elements of network 100 and implement the requested configuration (step 508). For example, controller 320 may identify the network elements that will be affected by the change in configuration, and transmit instructions to each of the affected network elements in order to adjust how those network elements operate in regard to UE 110 (e.g., without impacting how the network elements perform their functions for other UEs on telecom network 100). The instructions may for example direct the network elements to set up or tear down virtual machines used for mobility tracking.

Controller 320 then operates interface 310 to transmit a message to UE 110 via base station 120, indicating that the requested configuration has been implemented. This enables UE 110 to adjust its own internal settings as needed to adapt to the changes to telecom network 100.

Methods 400 and 500 illustrate how a communication network may be enhanced to use input from UEs in order to set/alter the way that the network interacts with those UEs. This provides a benefit, because it allows for efficient assignment of mobility anchors to UEs. This efficient assignment in turn leaves more network resources available on the network, ensuring that a larger overall number of UEs may be served by the network as compared to communication networks not enhanced as described herein.

In a further embodiment, after powering on, controller 220 identifies base station 120 based on periodically transmitted messages from base station 120. Controller 220 further identifies an existing configuration of network 100, based on communications with the base station 120, previous interactions with network 100, or locally stored information. The existing configuration of the network indicates a “default” methodology for operating network elements, and may for example indicate which network element should serve as a mobility anchor for UE 110. The existing configuration may further indicate how settings for reliability, security, battery saving, communication times, device content caching and quality of service should be configured. For example, the existing configuration may define how mobility anchors are assigned to UEs on network 100, or how communications are routed through the network.

In this embodiment, controller 220 analyzes the current configuration of network 100, and determines that the placement of a mobility anchor is not desirable for UE 110. For example, if UE 110 is highly mobile, a mobility anchor may be desired that encompasses a larger number of base stations, such as a network element that is further “upstream” from the default mobility anchor that would normally be used by network 100. Similarly, if UE 110 is largely immobile, a mobility anchor covering a smaller number of base stations may be suitable. Thus, controller 220 determines a new configuration in network 100 for UE 110 that defines a new mobility anchor for UE 110. In one embodiment, the newly requested mobility anchor is defined as any network element that is “upstream” (or “downstream”) of the current mobility anchor.

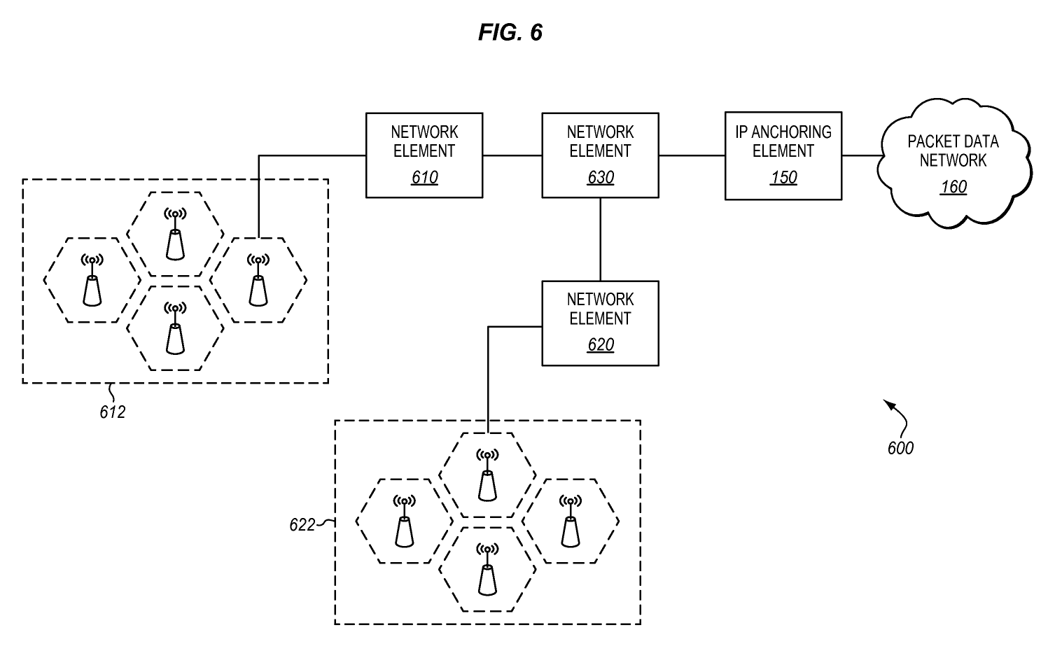

FIG. 6 is a block diagram 600 illustrating the concept of network elements that may serve as mobility anchors, and that are upstream or downstream with respect to each other. As shown in FIG. 6, network element 610 oversees a group of base stations 612, while another network element 620 oversees another group of base stations 622. For example, network element 610 oversees a group of four base stations 612, while network element 620 oversees another group of four base stations 622. However, network element 630 is placed upstream of network elements 610 and 620 (that is, closer to PDN 160 and further away from individual base stations) and oversees both groups of base stations 612, 622. Therefore, network element 630 encompasses a larger number of base stations than network elements 610 and 620.

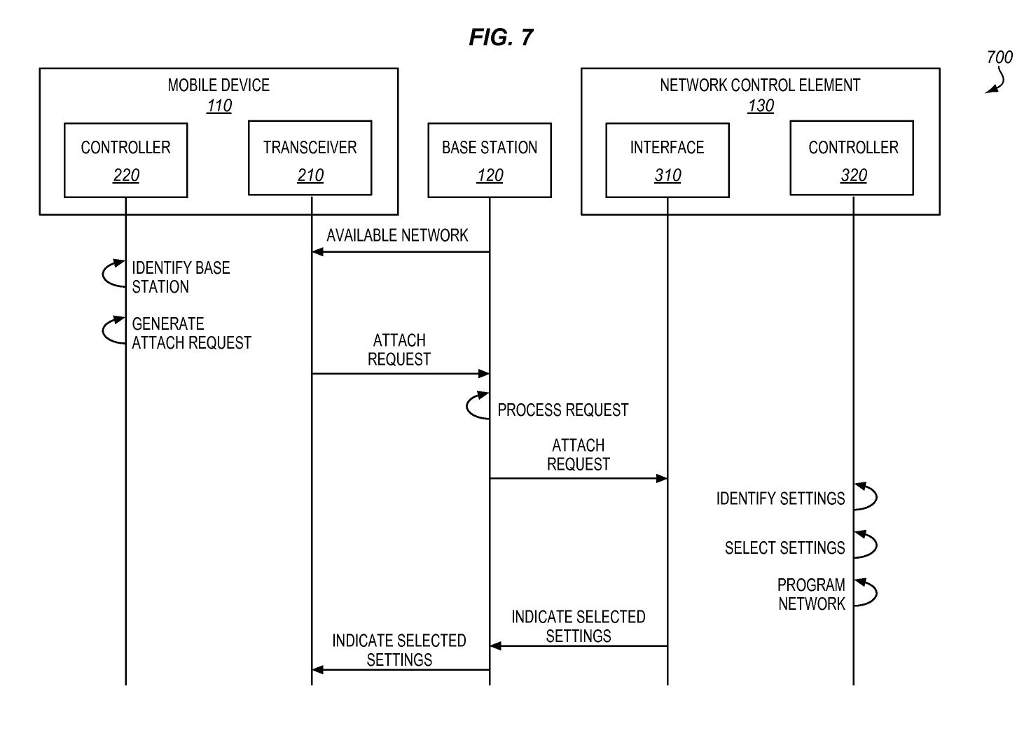

FIG. 7 is a message diagram 700 illustrating communications across telecom network 100 in an exemplary embodiment. Specifically, FIG. 7 summarizes an exemplary embodiment where methods 400 and 500 are performed. In FIG. 7, the process flow shows that a connection request in the form of an attach request is generated, transmitted, processed, and responded to by the various elements of telecom network 100. As a part of the process flow of FIG. 7, the new configuration indicated in the attach request is broken down into a set of discrete settings, which are each reviewed by controller 320. Controller 320 then decides which of the requested settings to implement, and transmits a message back to UE 110 indicating what settings of the new configuration will be used for UE 110.

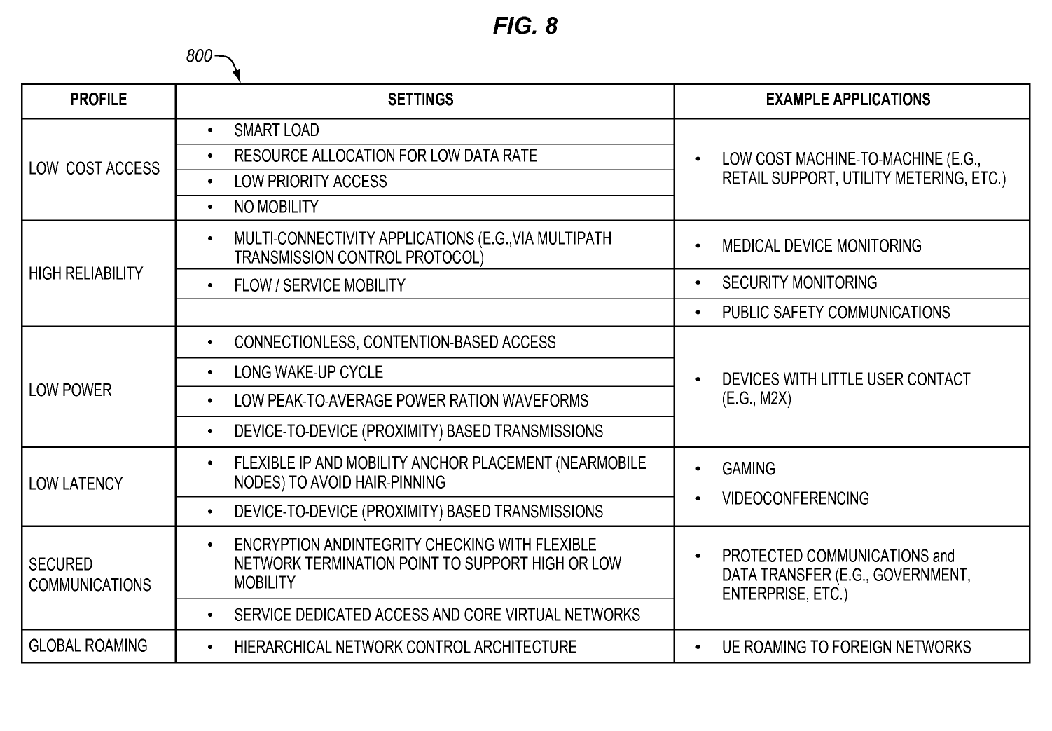

FIG. 8 illustrates exemplary configurations 800 requested by UEs in an exemplary embodiment. In this embodiment, each configuration is represented by a service profile. Each service profile includes a name indicating the general characteristic desired by a UE (or application thereof) that interacts with network 100 (e.g., “low cost access,” “high reliability,” etc.). Each service profile also includes settings for a hypothetical 5G network, such as settings that control the placement of mobility and IP anchors at the network, that control whether the transfer of data is connectionless (i.e., performed without first engaging in a handshake and reserving a channel with the base station), that control whether encryption is used for communications between the UE and a PDN, etc. FIG. 8 also lists a number of example applications that may request a certain service profile.

In a further embodiment, controller 220 of UE 110 uses a flag to indicate which settings should be selected or rejected together as a group. This grouping ensures that if one setting is not selected, other settings that depend on that setting will not be implemented as well. The flag may exist in the form of a name/tag for each group of settings within a profile, allowing multiple groups to be defined for each profile.

In a further embodiment, network control element 130 performs method 500 for each of the many UEs that enter telecom network 100 (and/or the individual applications of those UEs). The programming/configuring of the network elements is then indexed by device and/or application, so that each network element may service the needs of individual devices/applications on the network.

### EXAMPLES

In the following examples, additional processes, systems, and methods are described in the context of a UE that comprises a Machine to Machine (M2M) smart meter device, such as a smart meter that utilizes cellular protocols to report power consumption from a home or appliance, or a smart meter that monitors and reports the status of a patient at a hospital. According to this example, the smart meter detects the existence of an accessible RAN by detecting communications (e.g., packets/frames) from a nearby base station.

In this embodiment, the smart meter will utilize fewer network resources if a new network configuration is implemented for communicating with the smart meter. The new configuration is indicated by a service profile maintained at the smart meter. The smart meter, upon detecting the accessible RAN, proceeds to copy the service profile into a customized portion of a request to attach to the base station. The service profile (“LOW POWER”) describes desired settings of the UE for interacting with the telecom network. In this example, the requested settings include “connectionless access,” which saves battery and network resources since the smart meter will be used to transmit only small payloads of data. This also allows the smart meter to be charged at a lower tier of pricing at the RAN. The requested settings also indicate “no mobility” (since the device will be stationary once deployed), indicating that the base station used for the attach request may serve as the mobility anchor for the smart meter. The request further indicates that discontinuous reception (DRX) techniques will be used to communicate with the UE, and that predictive caching of data from a PDN using congestion avoidance scheduling (known as “smart loading”) should be used for the UE.

When the request to attach is received at the base station, the base station extracts the service profile from the request and forwards a condensed attach request (comprising the service profile along with identifying information such as a Subscriber Identity Module (SIM) identifier for the smart meter), to a network control element. In this example, the network control element is implemented by a blade server running a virtual machine on a processor and memory. This arrangement is colloquially known as a “virtualized network function,” even though the operations of the network control element are still performed by discrete hardware processors that implement instructions stored on tangible computer readable media.

The network control element proceeds to compare the request to an operator policy, as well as network analytics and subscriber analytics for the network. In this example, the operator policy indicates that the proposed downgrade in service should be granted, and the network and subscriber analytics indicate that the requested service features, because they reduce the overall amount of network resources used by the smart meter, are entirely acceptable. Therefore, the network control element starts configuring the cellular network to implement the requested new configuration. This configuration process is performed via Software Defined Networking (SDN) techniques. Specifically, resources for one or more virtual machines are allocated to the requested network functions, and the network functions are configured in order to enable long wake-up cycles and connectionless access when communicating with the smart meter. These network functions in turn are used to configure Wide Area Network (WAN) resources such as Virtual Private Networks (VPNs) in order to support bearer flow for data sent between the smart meter and the base station. When the network is properly programmed/configured, then the network control element contacts the smart meter via the base station, in order to inform the smart meter that the requested service features have been activated to support the transfer of data via network layer services of the cellular network. The smart meter is therefore attached to the base station and may reap the benefits of a network configured for its needs.

Any of the various elements shown in the figures or described herein may be implemented as hardware, software, firmware, or some combination of these. For example, an element may be implemented as dedicated hardware. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

1. An apparatus comprising:
User Equipment (UE) for a telecommunication network, the UE comprising:
a transceiver configured to communicate with a base station of a mobile operator network comprising a Radio Access Network (RAN) and a packet core; and
a controller configured to:
identify one or more applications residing on the UE, to determine a configuration for the mobile operator network that indicates how one or more elements of the mobile operator network will provide services for respective ones of the one or more applications identified as residing on the UE,
generate a signaling message that describes the configuration, and
transmit the signaling message to the base station to implement the configuration at the mobile operator network for setting how packets are transferred by the mobile operator network between the UE and a Packet Data Network (PDN).

2. The apparatus of claim 1, wherein:
the configuration indicates a mobility anchor to be used by the mobile operator network for the UE.

3. The apparatus of claim 1, wherein:
the configuration indicates whether to predictively cache content from the PDN at the UE.

4. The apparatus of claim 1, wherein:
the configuration indicates whether packets are transferred between the UE and the PDN without reserving a radio channel between the UE and the base station.

5. The apparatus of claim 1, wherein:
the configuration indicates whether a congestion avoidance scheduling technique will be used to communicate with the UE.

6. The apparatus of claim 1, wherein:
the controller is configured to include a profile within the signaling message, wherein the profile indicates the configuration.

7. The apparatus of claim 1, wherein:
the signaling message names a profile stored at the network; and
the profile indicates the configuration.

8. The apparatus of claim 1, wherein:
the configuration includes at least one network setting selected from the group consisting of: a mobility anchor setting, a security setting, a device content caching setting, a battery saving mode setting, a congestion avoidance scheduling setting, a quality of service setting, and a reliability setting.

9. An apparatus comprising:
a network control element of a mobile operator network that comprises a Radio Access Network (RAN) and a packet core, the network control element comprising:
an interface configured to receive a signaling message for a User Equipment (UE) via a base station; and
a controller configured to:
identify the UE that generated the signaling message,
analyze the signaling message to determine a requested configuration for the mobile operator network indicating how one or more elements of the mobile operator network will provide services for an identified application residing on the UE, and
program the one or more elements of the network to implement the requested configuration for the UE at the mobile operator network, thereby setting how packets are transferred by the mobile operator network between the UE and a Packet Data Network (PDN).

10. The apparatus of claim 9, wherein:
the configuration indicates a mobility anchor to be used by the mobile operator network for the UE.

11. The apparatus of claim 9, wherein:
the configuration indicates whether to predictively cache content from the PDN at the UE.

12. The apparatus of claim 9, wherein:
the configuration indicates whether packets are transferred between the UE and the PDN without reserving a radio channel between the UE and the base station.

13. The apparatus of claim 9, wherein:
the configuration indicates whether a congestion avoidance scheduling technique will be used to communicate with the UE.

14. The apparatus of claim 9, wherein:
the signaling message includes a profile that indicates the configuration.

15. The apparatus of claim 9, wherein:
the signaling message names a profile stored at the network; and
the profile indicates the configuration.

16. The apparatus of claim 9, wherein:
the configuration includes at least one network setting selected from the group consisting of: a mobility anchor setting, a security setting, a device content caching setting, a battery saving mode setting, a congestion avoidance scheduling setting, a quality of service setting, and a reliability setting.

17. A method, comprising:
receiving a signaling message for a User Equipment (UE) via a base station of a mobile operator network that comprises a Radio Access Network (RAN) and a packet core;
identifying the UE that generated the signaling message;
analyzing the signaling message to determine a requested configuration for the mobile operator network indicating how one or more elements of the mobile network will provide services for an identified application residing on the UE; and
programming the one or more elements of the network to implement the mobility anchor for the UE at the mobile operator network, thereby setting how packets are transferred by the mobile operator network between the UE and a Packet Data Network (PDN).

18. The method of claim 17, wherein:
the configuration includes at least one network setting selected from the group consisting of: a mobility anchor setting, a security setting, a device content caching setting, a battery saving mode setting, a congestion avoidance scheduling setting, a quality of service setting, and a reliability setting.

19. The method of claim 17, wherein:
the configuration indicates whether to predictively cache content from the PDN at the UE.

20. The method of claim 17, wherein:
the configuration indicates whether packets are transferred between the UE and the PDN without reserving a radio channel between the UE and the base station.
